(19) United States
(12) Patent Application Publication
(10) Pub. No.: US 2005/0192095 A1
(43) Pub. Date: Sep. 1, 2005

(54) Literal and/or verbal translator for game and/or A/V system

(76) Inventor: Chiu-Hao Cheng, Chung Ho City (TW)

Correspondence Address: RAYMOND Y. CHAN, 108 N. YNEZ AVE., SUITE 128, MONTEREY PARK, CA, 91754, US

(21) Appl. No.: 10/788,775

(22) Filed: Feb. 27, 2004

(51) Int. Cl. A63F 13/00

(52) U.S. Cl. 463/35

(57) ABSTRACT

A method for translating literal data of a video game includes the steps of: inputting audio/video signals of a video game into a video game player, wherein the audio/video signals contain text data to be displayed together with graphic scenes carried by the same; storing the audio/video signals in a memory module; extracting the text data from the audio/video signals stored in the memory module; translating the text data from one language into another; mixing the translated text data with the audio/video signals stored in the memory module; and displaying the audio/video signals together with the translated text data, whereby the video game is capable of communicating with a user who is familiar with the language the text data are translated into.

### BACKGROUND OF THE PRESENT INVENTION

1. Field of Invention

The present invention relates to a translator, and more particularly to a translator that is capable of translating literal and verbal information for video games and audio/video data.

2. Description of Related Arts

Video games are among the most popular home entertainments. A stand-alone play station or personal computer installed with certain programs can be used to play such video games. Conventionally, the video games are categorized into various categories, such as ACT (action games), RPG (role-playing games), RAC (race games), SLG (simulation games) and STG (shooting games), according to their various characteristics.

Some categories of video game contain a great amount of text information for interactively communicating with the player. For example, a RPG usually has several roles for the player choosing to play according to a pre-programmed script. The player may play the role of adventurer in search of treasure in an adventure, in the course of which the adventurer needs to talk to many characters for gathering information in order to find out the treasure. The conversation is often shown as dialog boxes containing text information on the screen, and sometimes it is accompanied with verbal information for achieving a better effect.

Very often the text information is written in a language, which cannot be understood by the player. This happens when the video game is manufactured in a country and sold to a player without translation added in another country, for example, that a Japanese video game is sold to an English-speaking player in the United States of America. When the player is playing such video game, he will not understand what most of the text information is about, and therefore his sense of entertainment will be greatly reduced.

In order to cope with the above problem, the video-game manufacturer would publish a reference book including some translations for a video game. The player who has a foreign-imported video game may additionally purchase the reference for the information of translation. As such, at some important stages of a game, the player may check with the reference book to acquire the crucial information from the translation.

One drawback is that not every video game is issued with such a reference book. If no such book is issued, the player will be left in the dark and will have to look up the dictionary for translations. Although the video game is issued with a reference book, it may not contain thorough and complete translation. As a result, the reference book cannot provide the player with the maximum amount of satisfaction that would have been given had the player totally understand the text information of the game. In addition, the reference book does not have the effect of real time translation, because he needs to pause the game and check with the book for certain translation. Furthermore, the reference book has no way to provide verbal translation, thereby reducing the level of entertainment, had verbal translation of the game's conversation been provided.

In view of the above paragraphs, what is needed is a method and device that are capable of real-time translation of text and verbal information contained in a video game for better entertaining the players.

### SUMMARY OF THE PRESENT INVENTION

An objective of the present invention is to provide a method that is able to translate the text or verbal information contained in a video game in real time for better entertaining the player.

Another objective of the present invention is to provide a method that is able to substitute the text or verbal information contained in a video game with the translated version in real-time display for better entertaining the players.

Another objective of the present invention is to provide a method that is able to display the text information contained in a video game with captions for translation in order to better entertain the players.

Another objective of the present invention is to provide a translator that is built-in a video game player computer for translating the text or verbal information contained in a video game, thereby better entertaining the players.

Another objective of the present invention is to provide an external translator adapted for connecting to a video game player computer for translating the text or verbal information contained in a video game, thereby better entertaining the players.

The present invention discloses a method for translating literal data of a video game comprising the following steps:
(1) inputting audio/video signals of a video game into a video game player, wherein the audio/video signals contain text data to be displayed together with graphic scenes carried by the same;
(2) storing the audio/video signals in a memory module;
(3) extracting the text data from the audio/video signals stored in the memory module;
(4) translating the text data from one language into another;
(5) mixing the translated text data with the audio/video signals stored in the memory module; and
(6) displaying the audio/video signals together with the translated text data, whereby the video game is capable of communicating with a user who is familiar with the language the text data are translated into.

These and other objectives, features, and advantages of the present invention will become apparent from the following detailed description, the accompanying drawings, and the appended claims.

### BRIEF DESCRIPTION OF THE DRAWINGS

FIG. 1 illustrates a functional block diagram of the translator according a preferred embodiment of the present invention.

FIG. 2 is a flowchart illustrating the method of translating the text information and characters into another language according to a preferred embodiment of the present invention.

### DETAILED DESCRIPTION OF THE PREFERRED EMBODIMENT

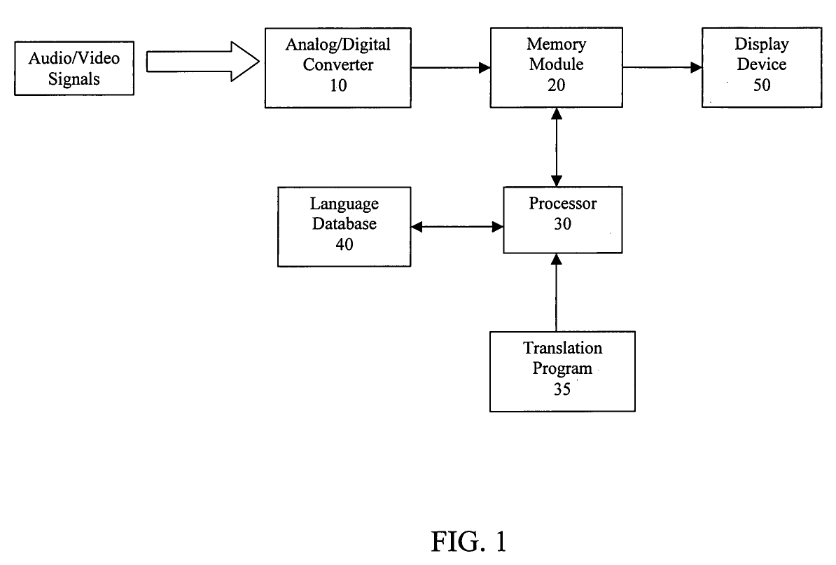

Referring to FIG. 1 of the drawings, a method for translating an information code of a video game according to a preferred embodiment of the present invention is illustrated, wherein the method comprises the following steps.

(1) Receive an audio/video signal from the video game, wherein the audio/video signal contains the information code interpreted in an original language to be output on a display device 50.

(2) Pre-store the audio/video signal in a memory module 20.

(3) Extract the information code from the audio/video signal in the memory module 20.

(4) Translate the information code from the original language into a selected language to form a translated data.

(5) Introduce the translated data back into the audio/video signal in the memory module 20.

(6) Output the audio/video signal with the translated data at the display device 50, in such a manner that a player of the video game is able to understand the translated data while the player is familiar with the selected language of the translated data.

According to the preferred embodiment, in order to perform the translation method as mentioned above, the present invention also provides a game translator for a game system comprising a processor 30 adapted for communicating with the memory module 20 to extract the information code from the audio/video signal in the memory module 20, and means 35 for translating the information code from an original language into a selected language to form a translated data, wherein the translated date is arranged for introducing back into the audio/video signal in the memory module 20 to be output.

Accordingly, the game system generally comprises a signal source, such as a video game player or a personal computer, for outputting the audio/video signal to the memory module 20. The audio/video signal contains the information code and a graphic information including characters in the form of picture. The characters often appear as integral parts of a graphic scene of the game.

The information code comprises a literal data and a verbal data, wherein the information code is usually separated from and displayed on the graphic scene for giving greater amount of conversational or literal information about the game. The characters and information code may also be accompanied with verbal information spelling out the content of the characters and text information. In other words, during the video game, not only the graphic information but also the corresponding information code is output through the display device 50 at the same time.

Accordingly, after step (1), the method further comprises a step of converting the audio/video signal into a digital form. Since the method can be implemented in an external device connected to a video game player or a built-in module of the same, the method may be dealing with the audio/video signal from various sources, wherein one of the sources may produce the audio/video signals in the analog form. In order to facilitate further processing, the step is needed to convert the audio/video signals into the digital form.

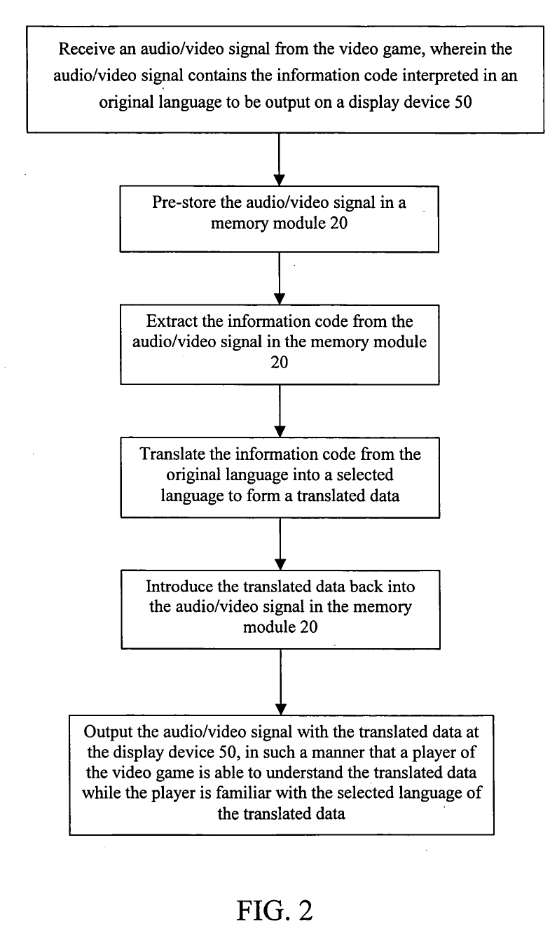

As shown in FIGS. 1 and 2, the digital converter 10 is linked to the memory module 20 for converting the audio/video signal into a digital form for processing in the memory module 20. In other words, the signal source may be a video game player or personal computer that is adapted for playing the video game to generate an analog audio/video output signal such that the digital converter 10 converts the analog audio/video signal output from the signal source into a digital audio/video signal. The digital converter 10 will non-discriminatorily translate all of the information into the digital form according to various categories of its nature.

The audio/video signal is transferred to the memory module 20, such as RAM and flash memory cards, for temporary storage before the audio/video signal is output to the display device 50.

The processor 30, which is electrically connected with the memory module 20, extracts the information code and graphic data containing characters from the audio/video signal stored in the memory module 20 for translation.

The step (3) includes a step of extracting graphic-character data from the audio/video signal. The information code is contained in the audio/video signal as the types of file different from those of the graphic data contained therein. The information code is fairly easy to be extracted from the audio/video signal because they are stored in the types of file easily identified from graphic data. The graphic-character data is the types of file of graphic in nature, but containing characters of literal meanings. As a result, they are not as easy to identify as the information code. In order to identify those graphic-character data, the graphic frames contained in the audio/video signal are compared with sample patterns of words in a particular language. The identified characters are associated with their literal meanings of the sample patterns, and then the graphic-character data are extracted from the audio/video signals for further translation.

Accordingly, the translating means 35 is a translation program loaded in the processor 30 for translating the information code into a selected language to be output at the display device 40. The translation program of the translating means 35, which is prepared for supporting the processor 30 to extract the information code from the memory module 20, can be made as an internal circuitry embedded in the processor 30 or an external circuitry or software, whose programs are to be read into the processor 30 upon tuning-on of the game translator.

The translating means 35 is adapted to translate the literal data of the information code in the memory module 20 as the translated data to be output at the display device 50 in text message manner. The literal data of the information code is then substituted by the translated data to be output at the display device 50. Alternatively, the translated data is captioned to be output at the display device 50.

In addition, the verbal data of the information code in the memory module 20 is translated through the translating means 35 as the translated data and is output at the display device 50 in voice message manner, wherein the verbal data of the information code is replaced by the translated data to be output at the display device 50.

The step (4) further comprises a step of searching the information code from a language database 40 for matching a closest meaning of the information code corresponding to the translated data.

In the step (5), the translated text data with the audio/video signal can be done in two ways, substituting or captioning. As for substituting, the translated data retrieved from the language database 40 will replace the original text data contained in the audio/video signal, so that when the audio/video signal is displayed, the text will appear in the translated langue for better communicating with the player. As for captioning, the translated text data will be displayed as captions along side the original text data, which are also displayed in real-time.

The language database 40 electrically linked to the processor 30 wherein the translating means 35 searches the language database to obtain the closest meaning of the information code corresponding to the translated data. Accordingly, the database 40 contains an electronic dictionary for translating one language from another while various types of data require various processes of translation.

For the literal data, the processor 30 would search the language database 40 based on the words of the literal data, and extracts the corresponding translation of the words therefrom. The translated data would be put back to the memory module 20, according to their original association with other data of the audio/video signal for later displaying on the display device 50. In this preferred embodiment, the translated data will substitute the original text data, such that when the audio/video signal is displayed on the display device 50, the video game will include the text information that is translated into the langue understood by the player, and the text information in the original language will no longer be there. In order to have the text information properly translated, the correctness of grammar needs be considered because sometimes a word-to-word translation may not faithfully carry the original meaning of the text information. Thus, the translating means 35 may include a function of reordering the words translated from the original text information according to the correctness of grammar.

It is noted that the game translator can also translate the text information in a way of captioning. For example, the processor 30 translates the original text information into another language and attaches the translated text information like subtitles along side the original information when the audio/video information is played on the display device 50.

The processor 30 can also translate characters contained in graphic data by means of what is similar to Optical Character Recognition (OCR) technology. The processor 30 loaded with the translating means 35 identifies the characters contained in the graphic data. The identified characters are compared with the words stored in the language database 40 for reading of their exact meanings, and their corresponding translations would be retrieved from the language database 40. Because it is very difficult to substitute the characters with the translated data, they would be played as captions with the graphic data on the display device 50.

Likewise, the processor 30, loaded with the program 35, can translate the verbal data into another langue. The processor 30 extracts the verbal data contained in the audio/video signal stored in the memory module 20. The verbal data are broken down into words, which would be checked against the language database 40 for identifying the exact words the verbal data represent. The addresses of the corresponding translations of the identified words are then located in the language database 40 and synthesized for pronunciation.

Furthermore, in step (4), the method further comprises the steps for translating the verbal data of the audio/video signal from the original language into the selected language, comprising:
(4.1) extracting verbal data contained in the audio/video signal from the audio/video signal;
(4.2) breaking down the verbal data in a word-by-word manner;
(4.3) identifying the meanings of the verbal data in a word-by-word manner;
(4.4) searching the language database 40 for verbal translations representing pronunciations of the selected language with respect to the verbal data;
(4.5) introducing the verbal translations back to the audio/video signal in the memory module 20; and

(4.6) outputting the verbal translations with the audio/video signal in real time.

In view of above, the present invention has an advantage of enabling a player to play a video game with the literal and verbal information translated into the language she understands in real-time. Thus, the player will not need to look for a reference book that might contain insufficient translations for playing the game. The invention may be implemented as a built-in module of the video game player or an external device to be connected with the same. As such, the disclosed invention enables the video-game players to access foreign video games that they would not have been able to play for the language barriers.

In addition, the game translator can be made as a circuitry or software program built in a video game player or personal computer. It can also be made as an external device of translation to be electrically connected to a video game player or personal computer.

How the abovementioned elements work together are briefed as following. The memory module 20 is suitable for temporary storing audio/video signal of the video game inputted by the video game player, wherein the audio/video signal contains information data and the graphic data to be output at the display device 50 at the same time. The language database 40 contains translation data of a language different from that of the information code. The processor 30 loaded with the translating means 35, electrically connected with the memory module 20 and the language database 40, is capable of extracting the literal data and the verbal data from the audio/video signal stored in the memory module 20, searching the database 40 for translations with respect to the literal data and the verbal data, and introducing the translated data back to the audio/video signal stored in the memory module 20. The display device 50, electrically connected to the memory module 20, is used for outputting the audio/video signal together with the translated data, whereby the video game is capable of communicating with a user who is familiar with the selected language of the literal data and the verbal data.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A method for translating an information code of a video game, comprising the steps of:
(a) receiving an audio/video signal from said video game, wherein said audio/video signal contains said information code interpreted in an original language to be output on a display device;
(b) pre-storing said audio/video signal in a memory module;
(c) extracting said information code from said audio/video signal in said memory module;
(d) translating said information code from said original language into a selected language to form a translated data;
(e) introducing said translated data back into said audio/video signal in said memory module; and
(f) outputting said audio/video signal with said translated data at said display device, in such a manner that a player of said video game is able to understand said translated data while said player is familiar with said selected language of said translated data.

2. The method, as recited in claim 1, wherein said information code comprises a literal data to be translated as said translated data in said memory module and to be output at said display device in text message manner.

3. The method, as recited in claim 2, wherein said information code is substituted by said translated data to be output at said display device.

4. The method, as recited in claim 2, wherein said translated data is captioned to be output at said display device.

5. The method as recited in claim 2, in step (d), further comprising a step of searching said information code from a language database for matching a closest meaning of said information code corresponding to said translated data.

6. The method, as recited in claim 2, after step (a), further comprising a step of converting said audio/video signal into a digital form for processing in said memory module.

7. The method, as recited in claim 5, after step (a), further comprising a step of converting said audio/video signal into a digital form for processing in said memory module.

8. The method, as recited in claim 1, wherein said information code comprises a verbal data to be translated as said translated data in said memory module and to be output at said display device in voice message manner.

9. The method, as recited in claim 8, wherein said information code is replaced by said translated data to be output at said display device.

10. The method as recited in claim 8, in step (d), further comprising a step of searching said information code from a language database for matching a closest meaning of said information code corresponding to said translated data.

11. The method, as recited in claim 8, after step (a), further comprising a step of converting said audio/video signal into a digital form for processing in said memory module.

12. The method, as recited in claim 10, after step (a), further comprising a step of converting said audio/video signal into a digital form for processing in said memory module.

13. The method, as recited in claim 1, wherein said information code comprises a literal data and a verbal data to be translated as said translated data in said memory module, wherein said literal data is output at said display device in text message manner and said verbal data is output at said display device in voice message manner.

14. The method as recited in claim 13, in step (d), further comprising a step of searching said information code from a language database for matching a closest meaning of said information code corresponding to said translated data.

15. The method, as recited in claim 14, after step (a), further comprising a step of converting said audio/video signal into a digital form for processing in said memory module.

16. A game system, comprising:
a memory module for pre-storing an audio/video signal containing an information date to be output, and
a game translator comprising a processor communicating with said memory module to extract said information code from said audio/video signal in said memory module; and means for translating said information code from an original language into a selected language to form a translated data, wherein said translated date is introduced back into said audio/video signal in said memory module to be output.

17. The game system, as recited in claim 16, wherein said translating means is a translation program loaded in said processor for translating a literal data of said information code into a selected language to be output in text message manner.

18. The game system, as recited in claim 16, wherein said translating means is a translation program loaded in said processor for translating a verbal data of said information code into a selected language to be output in voice message manner.

19. The game system, as recited in claim 17, further comprising a language database linked to said processor wherein said translating means searches in said language database for matching a closest meaning of said information code corresponding to said translated data.

20. The game system, as recited in claim 18, further comprising a language database linked to said processor wherein said translating means searches in said language database for matching a closest meaning of said information code corresponding to said translated data.

21. The game system, as recited in claim 19, further comprising a digital converter electrically connected to said memory module for converting said audio/video signal into a digital form in said memory module.

22. The game system, as recited in claim 20, further comprising a digital converter electrically connected to said memory module for converting said audio/video signal into a digital form in said memory module.
